(19) United States
(12) Patent Application Publication
(10) Pub. No.: US 2024/0205690 A1
(43) Pub. Date: Jun. 20, 2024

(54) METHOD FOR SHARING BASEBAND COMPUTING RESOURCES

(71) Applicant: NOKIA SOLUTIONS AND NETWORKS OY, Espoo (FI)

(72) Inventors: Scaria KURIAN, Bangalore (IN); Georgi J MELETH, Bangalore (IN); Nitin Chittilappilly J, Bangalore (IN); Petri Olavi JAPPILA, Helsinki (FI)

(21) Appl. No.: 18/555,755

(22) PCT Filed: Apr. 19, 2022
(86) PCT No.: PCT/EP2022/060211

§ 371 Date: Oct. 17, 2023

(30) Foreign Application Priority Data
Apr. 19, 2021 (FI) 20215461
Apr. 20, 2021 (FI) 20215463

(51) Int. Cl. H04W 16/14; H04W 72/52; H04W 92/20; H04W 92/24

(52) U.S. Cl. CPC H04W 16/14; H04W 72/52; H04W 92/20; H04W 92/24

(57) ABSTRACT

An apparatus comprising means for determining, from a baseband processing resource pool distributable among a plurality of cells, a maximum baseband processing resource capacity allocated for each of said cells; means for determining an available baseband processing resource capacity of each of said cells; means for determining an aggregate available baseband processing resource capacity of said baseband processing resource pool; and means for providing a control unit controlling said apparatus with an indication comprising identities of cells belonging to said baseband processing resource pool, the maximum and the available baseband processing resource capacity for each of said cells and the aggregate available baseband processing resource capacity of said baseband processing resource pool.

### TECHNICAL FIELD

The present invention relates to sharing of baseband computing resources.

### BACKGROUND

5G specifications provide an option to split the internal structure of an access node gNodeB (gNB) into entities called CU (Central Unit) and one or more DUs (Distributed Unit), which are connected by a F1 interface, as specified in 3GPP 38.473. The split may provide traffic aggregation in terms of one gNB CU (or gNB-CU) serving a plurality of gNB DUs (or gNB-DU) operating as the actual node points for the air interface. There may also be a RAN (Radio Access Network) intelligent controller (RIC) connected through an E2 interface to the nodes gNB-DU and gNB-CU. RIC is a logical function that may be further divided into functions of a non-real-time RIC and a near-real-time RIC. The near-real-time RIC enables near-real-time control and optimization of RAN elements and resources via fine-grained data collection and actions over E2 interface.

The DU has fixed computing resources to be used, for example, for establishing calls, handling user plane (U-plane) data, scheduling etc. The DU's computing resources are further split among cells, and the real time resources within a cell are dedicated. The cells utilise their respective real time computing resources differently due to varying cell load and number of users. For addressing the dynamic variation of the real time computing resources between the cells, the DU may be provided with a baseband resource pooling functionality, which enables to share the computing resources between cells based on cell loads.

Current F1 and E2 interfaces have procedures defined for radio resource and hardware load reporting at cell level and network slice level. With baseband pooling, the computing resource load now depends also on other cells in the pool. However, central control entities, like gNB-CU or near real time RIC functionality, have no means to know which baseband computing resources are shared/pooled e.g. by multiple cells, or which parameters are dynamic per cell. Therefore, the lack of information in the central control components can hinder efficient use of baseband resources when gNB-DU supports pooling functionality.

### SUMMARY

Now, an improved method and technical equipment implementing the method has been invented, by which the above problems are alleviated. Various aspects include a method, an apparatus and a non-transitory computer readable medium comprising a computer program, or a signal stored therein, which are characterized by what is stated in the independent claims. Various details of the embodiments are disclosed in the dependent claims and in the corresponding images and description.

The scope of protection sought for various embodiments of the invention is set out by the independent claims. The embodiments and features, if any, described in this specification that do not fall under the scope of the independent claims are to be interpreted as examples useful for understanding various embodiments of the invention.

According to a first aspect, there is provided an apparatus comprising means for determining, from a baseband processing resource pool distributable among a plurality of cells, a maximum baseband processing resource capacity allocated for each of said cells; means for determining an available baseband processing resource capacity of each of said cells; means for determining an aggregate available baseband processing resource capacity of said baseband processing resource pool; and means for providing a control unit controlling said apparatus with an indication comprising identities of cells belonging to said baseband processing resource pool, the maximum and the available baseband processing resource capacity for each of said cells and the aggregate available baseband processing resource capacity of said baseband processing resource pool.

An apparatus according to a second aspect comprises at least one processor and at least one memory, said at least one memory stored with computer program code thereon, the at least one memory and the computer program code configured to, with the at least one processor, cause the apparatus at least to perform: determine, from a baseband processing resource pool distributable among a plurality of cells, a maximum baseband processing resource capacity allocated for each of said cells; determine an available baseband processing resource capacity of each of said cells; determine an aggregate available baseband processing resource capacity of said baseband processing resource pool; and provide a control unit controlling said apparatus with an indication comprising identities of cells belonging to said baseband processing resource pool, the maximum and the available baseband processing resource capacity for each of said cells and the aggregate available baseband processing resource capacity of said baseband processing resource pool.

According to an embodiment, the apparatus is comprised in a distributed unit of an access node and the control unit is comprised in a central unit of said access node.

According to an embodiment, said indication is provided over F1 interface or over X2/Xn interface.

According to an embodiment, the apparatus is comprised in a distributed unit of an access node and the control unit is comprised in a radio access network controller.

According to an embodiment, the apparatus is comprised in a distributed unit of an access node and the control unit is comprised in a radio access network intelligent controller, wherein said indication is provided over E2 interface.

According to an embodiment, the control unit is comprised in a near-real-time radio access network intelligent controller.

According to an embodiment, the apparatus comprises computer program code configured to cause the apparatus to perform: share the baseband processing resources among the cells belonging to the pool for radio resource control (RRC) connections or bearers.

According to an embodiment, the apparatus comprises computer program code configured to cause the apparatus to perform: provide the control unit with an indication comprising information about available processing power for the available baseband processing resource capacity.

According to an embodiment, the apparatus comprises computer program code configured to cause the apparatus to perform: inform its aggregate available baseband processing resource capacity of said baseband processing resource pool to be used for at least one participating cell of the baseband processing resource pool.

According to an embodiment, the apparatus comprises computer program code configured to cause the apparatus to perform: inform the control unit about changes in pooling boundaries of baseband processing resource pools supported by the distributed unit.

According to an embodiment, the apparatus comprises computer program code configured to cause the apparatus at least to perform: inform its aggregate available and maximum baseband processing resource capacity of said baseband processing resource pool in response to a change in baseband processing resource allocation.

According to an embodiment, the apparatus comprises computer program code configured to cause the apparatus at least to perform: set at least one threshold value, received from a control unit, for a load in baseband processing resource allocation; and send an update of its aggregate available and maximum baseband processing resource capacity of said baseband processing resource pool in response reaching said threshold value.

According to an embodiment, the apparatus comprises computer program code configured to cause the apparatus at least to perform: receive, from the control unit, runtime reconfiguration of participating cells in the cell pool/group defined based on cell load information.

A method according to a third aspect comprises determining, by an apparatus provided with a baseband processing resource pool distributable among a plurality of cells, a maximum baseband processing resource capacity allocated for each of said cells; determining an available baseband processing resource capacity of each of said cells; determining an aggregate available baseband processing resource capacity of said baseband processing resource pool; and providing a control unit controlling said apparatus with an indication comprising identities of cells belonging to said baseband processing resource pool, the maximum and the available baseband processing resource capacity for each of said cells and the aggregate available baseband processing resource capacity of said baseband processing resource pool.

Computer readable storage media according to further aspects comprise code for use by an apparatus, which when executed by a processor, causes the apparatus to perform the above methods.

### BRIEF DESCRIPTION OF THE DRAWINGS

For a more complete understanding of the example embodiments, reference is now made to the following descriptions taken in connection with the accompanying drawings in which:

FIG. 1 shows a schematic block diagram of an apparatus for incorporating functionalities for implementing various embodiments;

FIG. 2 shows schematically a layout of an apparatus according to an example embodiment;

FIG. 3 shows a part of an exemplifying radio access network;

FIG. 4 illustrates overview on the 5G deployment model for the split gNB;

FIG. 5 shows an example how the available and maximum RRC capacity per cell varies dynamically with baseband pooling at different time instants;

FIG. 6 shows a flow chart for a method for reporting baseband computing resources to a central unit according to an embodiment;

FIG. 7 shows an exemplified signalling chart for the exchange of cell pooling information over F1-AP according to an embodiment;

FIG. 8 shows an exemplified signalling chart for reporting of available and maximum capacity at cell pool and cell level according to an embodiment;

FIG. 9 shows an exemplified signalling chart for threshold triggered load reporting according to an embodiment; and

FIG. 10 shows an exemplified signalling chart for messages exchanged on E2 interface according to an embodiment.

### DETAILED DESCRIPTION OF SOME EXAMPLE EMBODIMENTS

The following describes in further detail suitable apparatus and possible mechanisms carrying out the operations for sharing baseband computing resources from a pool of resources. While the following focuses on 5G networks, the embodiments as described further below are by no means limited to be implemented in said networks only, but they are applicable in any network and protocol entities supporting the split of the internal structure of an access node into a central unit and one or more distributed units.

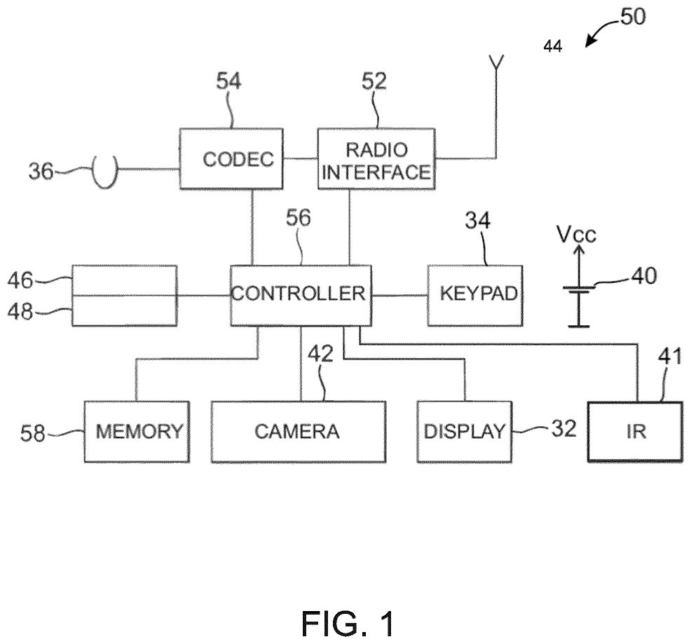

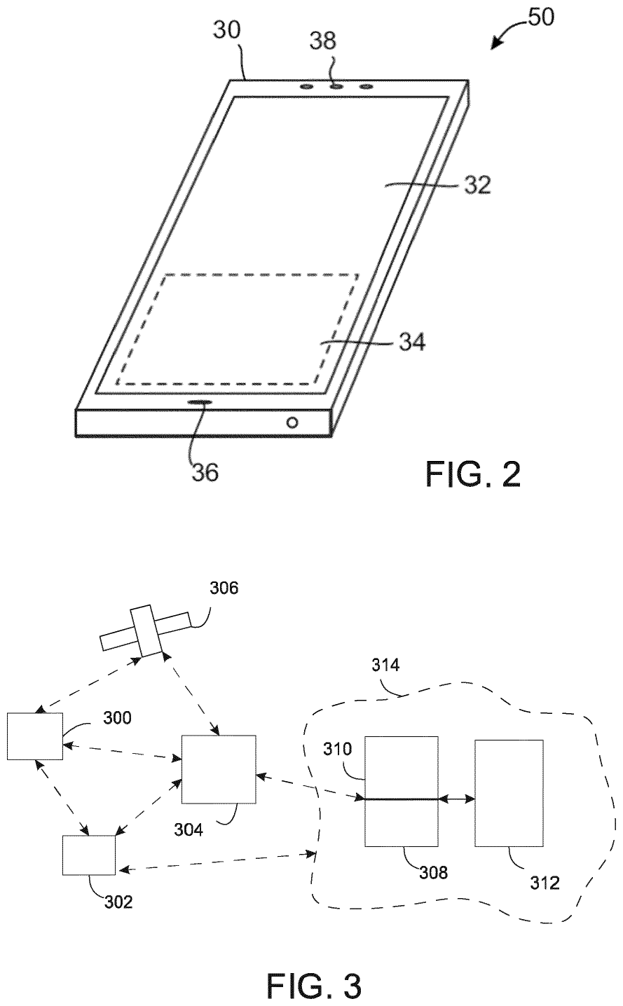

In this regard, reference is first made to FIGS. 1 and 2, where FIG. 1 shows a schematic block diagram of an exemplary apparatus or electronic device 50, which may incorporate the arrangement according to the embodiments. FIG. 2 shows a layout of an apparatus according to an example embodiment. The elements of FIGS. 1 and 2 will be explained next.

The electronic device 50 may for example be a user device, a mobile terminal or user equipment of a wireless communication system. The apparatus 50 may comprise a housing 30 for incorporating and protecting the device. The apparatus 50 further may comprise a display 32 and a keypad 34. Instead of the keypad, the user interface may be implemented as a virtual keyboard or data entry system as part of a touch-sensitive display.

The apparatus may comprise a microphone 36 or any suitable audio input which may be a digital or analogue signal input. The apparatus 50 may further comprise an audio output device, such as anyone of: an earpiece 38, speaker, or an analogue audio or digital audio output connection. The apparatus 50 may also comprise a battery 40 (or the device may be powered by any suitable mobile energy device such as solar cell, fuel cell or clockwork generator). The apparatus may further comprise a camera 42 capable of recording or capturing images and/or video. The apparatus 50 may further comprise an infrared port 41 for short range line of sight communication to other devices. In other embodiments the apparatus 50 may further comprise any suitable short-range communication solution such as for example a Bluetooth wireless connection or a USB/firewire wired connection.

The apparatus 50 may comprise a controller 56 or processor for controlling the apparatus 50. The controller 56 may be connected to memory 58 which may store both user data and instructions for implementation on the controller 56. The memory may be random access memory (RAM) and/or read only memory (ROM). The memory may store computer-readable, computer-executable software including instructions that, when executed, cause the controller/processor to perform various functions described herein. In some cases, the software may not be directly executable by the processor but may cause a computer (e.g., when compiled and executed) to perform functions described herein. The controller 56 may further be connected to codec circuitry 54 suitable for carrying out coding and decoding of audio and/or video data or assisting in coding and decoding carried out by the controller.

The apparatus 50 may comprise radio interface circuitry 52 connected to the controller and suitable for generating wireless communication signals for example for communication with a cellular communications network, a wireless communications system or a wireless local area network. The apparatus 50 may further comprise an antenna 44 connected to the radio interface circuitry 52 for transmitting radio frequency signals generated at the radio interface circuitry 52 to other apparatus(es) and for receiving radio frequency signals from other apparatus(es).

In the following, different exemplifying embodiments will be described using, as an example of an access architecture to which the embodiments may be applied, a radio access architecture based on Long Term Evolution Advanced (LTE Advanced, LTE-A) or new radio (NR, 5G), without restricting the embodiments to such an architecture, however. A person skilled in the art appreciates that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet protocol multimedia subsystems (IMS) or any combination thereof.

FIG. 3 depicts examples of simplified system architectures only showing some elements and functional entities, all being logical units, whose implementation may differ from what is shown. The connections shown in FIG. 3 are logical connections; the actual physical connections may be different. It is apparent to a person skilled in the art that the system typically comprises also other functions and structures than those shown in FIG. 3. The embodiments are not, however, restricted to the system given as an example but a person skilled in the art may apply the solution to other communication systems provided with necessary properties.

The example of FIG. 3 shows a part of an exemplifying radio access network.

FIG. 3 shows user devices 300 and 302 configured to be in a wireless connection on one or more communication channels in a cell with an access node (such as (e/g)NodeB or a base transceiver station (BTS)) 304 providing the cell. The physical link from a user device to a (e/g)NodeB is called uplink or reverse link and the physical link from the (e/g)NodeB to the user device is called downlink or forward link. It should be appreciated that (e/g)NodeBs or their functionalities may be implemented by using any node (such as Integrated Access and Backhaul (IAB) node), host, server or access point etc. entity suitable for such a usage.

A communication system typically comprises more than one (e/g)NodeB in which case the (e/g)NodeBs may also be configured to communicate with one another over links, wired or wireless, designed for the purpose. These links may be used for signaling purposes. The (e/g)NodeB is or comprises a computing device configured to control the radio resources of communication system it is coupled to. The NodeB may also be referred to as a base station, an access point, an access node or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g) NodeB is further connected to core network 310 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc. The CN may comprise network entities or nodes that may be referred to management entities. Examples of the network entities comprise at least an Access and Mobility Management Function (AMF).

In 5G NR, the User Plane Function (UPF) may be used to separate the control plane and the user plane functions. Therein, the Packet Gateway (PGW) control and user plane functions may be decoupled, whereby the data forwarding component (PGW-U) may be decentralized, while the PGW-related signaling (PGW-C) may remain in the core. This allows packet processing and traffic aggregation to be performed closer to the network edge, increasing bandwidth efficiencies while reducing network.

The user device (also called a user equipment (UE), a user terminal, a terminal device, a wireless device, a mobile station (MS) etc.) illustrates one type of an apparatus to which resources on the air interface are allocated and assigned, and thus any feature described herein with a user device may be implemented with a corresponding network apparatus, such as a relay node, an eNB, and an gNB. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IOT) network which is a scenario in which objects are provided with the ability to transfer data over a network without requiring human-to-human or human-to-computer interaction. Accordingly, the user device may be an IoT-device. The user device may also utilize cloud. In some applications, a user device may comprise a small portable device with radio parts (such as a watch, earphones or eyeglasses) and the computation is carried out in the cloud. The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input—multiple output (MIMO) antennas, many more base stations or nodes than the LTE (a so-called small cell concept), including macro sites operating in co-operation with smaller stations and employing a variety of radio technologies depending on service needs, use cases and/or spectrum available. The access nodes of the radio network form transmission/reception (TX/Rx) points (TRPs), and the UEs are expected to access networks of at least partly overlapping multi-TRPs, such as macro-cells, small cells, pico-cells, femto-cells, remote radio heads, relay nodes, etc. The access nodes may be provided with Massive MIMO antennas, i.e. very large antenna array consisting of e.g. hundreds of antenna elements, implemented in a single antenna panel or in a plurality of antenna panels, capable of using a plurality of simultaneous radio beams for communication with the UE. The UEs may be provided with MIMO antennas having an antenna array consisting of e.g. dozens of antenna elements, implemented in a single antenna panel or in a plurality of antenna panels. Thus, the UE may access one TRP using one beam, one TRP using a plurality of beams, a plurality of TRPs using one (common) beam or a plurality of TRPs using a plurality of beams.

The 4G/LTE networks support some multi-TRP schemes, but in 5G NR the multi-TRP features are enhanced e.g. via transmission of multiple control signals via multi-TRPs, which enables to improve link diversity gain. Moreover, high carrier frequencies (e.g., mmWaves) together with the Massive MIMO antennas require new beam management procedures for multi-TRP technology.

5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 6 GHz, cmWave and mmWave, and also capable of being integrated with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT (Radio Access Technology) operability (such as LTE-5G) and inter-RI operability (inter-radio interface operability, such as below 6 GHz—cmWave, below 6 GHz—cmWave—mmWave). One of the concepts considered to be used in 5G networks is network slicing in which multiple independent and dedicated virtual sub-networks (network instances) may be created within the same infrastructure to run services that have different requirements on latency, reliability, throughput and mobility.

Frequency bands for 5G NR are separated into two frequency ranges: Frequency Range 1 (FR1) including sub-6 GHz frequency bands, i.e. bands traditionally used by previous standards, but also new bands extended to cover potential new spectrum offerings from 410 MHz to 7125 MHZ, and Frequency Range 2 (FR2) including frequency bands from 24.25 GHz to 52.6 GHz. Thus, FR2 includes the bands in the mmWave range, which due to their shorter range and higher available bandwidth require somewhat different approach in radio resource management compared to bands in the FR1.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 312, or utilize services provided by them. The communication network may also be able to support the usage of cloud services, for example at least part of core network operations may be carried out as a cloud service (this is depicted in FIG. 3 by “cloud” 314). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head, radio unit (RU) or base station comprising radio parts. It is also possible that node operations will be distributed among a plurality of servers, nodes or hosts. Application of cloudRAN architecture enables RAN real time functions being carried out at the RAN side (e.g. in a distributed unit, DU) and non-real time functions being carried out in a centralized manner (e.g. in a centralized unit, CU 308).

While Cloud RAN and Open RAN (ORAN or O-RAN) may have ties and may often be discussed together, they may also be considered as different technologies and one can be applied without the other. Open RAN for example defines open interfaces between network elements, while Cloud RAN for example may virtualize the baseband and separate baseband hardware and software. The open radio access network, O-RAN, as defined by the Open RAN Alliance, refers to a concept enabling interoperability of RAN elements between different vendors over a set of defined interfaces. Thus, O-RAN architecture for example enables baseband unit and radio unit components from different vendors to operate together.

It should also be understood that the distribution of labor between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (e/gNB). It should be appreciated that MEC can be applied in 4G networks as well. The gNB is a next generation Node B (or, new Node B) supporting the 5G network (i.e., the NR).

5G may also utilize non-terrestrial nodes 306, e.g. access nodes, to enhance or complement the coverage of 5G service, for example by providing backhauling, wireless access to wireless devices, service continuity for machine-to-machine (M2M) communication, service continuity for Internet of Things (IOT) devices, service continuity for passengers on board of vehicles, ensuring service availability for critical communications and/or ensuring service availability for future railway/maritime/aeronautical communications. The non-terrestrial nodes may have fixed positions with respect to the Earth surface or the non-terrestrial nodes may be mobile non-terrestrial nodes that may move with respect to the Earth surface. The non-terrestrial nodes may comprise satellites and/or HAPSs (High Altitude Platform Stations). Satellite communication may utilize geostationary earth orbit (GEO) satellite systems, but also low earth orbit (LEO) satellite systems, in particular mega-constellations (systems in which hundreds of (nano)satellites are deployed). Each satellite in the mega-constellation may cover several satellite-enabled network entities that create on-ground cells. The on-ground cells may be created through an on-ground relay node 304 or by a gNB located on-ground or in a satellite.

A person skilled in the art appreciates that the depicted system is only an example of a part of a radio access system and in practice, the system may comprise a plurality of (e/g)NodeBs, the user device may have an access to a plurality of radio cells and the system may comprise also other apparatuses, such as physical layer relay nodes or other network elements, etc. At least one of the (e/g)NodeBs or may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells.

The (e/g)NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H(e/g)nodeBs), a home node B gateway, or HNB-GW (not shown in FIG. 1). A HNB Gateway (HNB-GW), which is typically installed within an operator's network may aggregate traffic from a large number of HNBs back to a core network.

The Radio Resource Control (RRC) protocol is used in various wireless communication systems for defining the air interface between the UE and a base station, such as eNB/gNB. This protocol is specified by 3GPP in in TS 36.331 for LTE and in TS 38.331 for 5G. In terms of the RRC, the UE may operate in LTE and in 5G in an idle mode or in a connected mode, wherein the radio resources available for the UE are dependent on the mode where the UE at present resides. In 5G, the UE may also operate in inactive mode. In the RRC idle mode, the UE has no connection for communication, but the UE is able to listen to page messages. In the RRC connected mode, the UE may operate in different states, such as CELL_DCH (Dedicated Channel), CELL_FACH (Forward Access Channel), CELL_PCH (Cell Paging Channel) and URA_PCH (URA Paging Channel). The UE may communicate with the eNB/gNB via various logical channels like Broadcast Control Channel (BCCH), Paging Control Channel (PCCH), Common Control Channel (CCCH), Dedicated Control Channel (DCCH), Dedicated Traffic Channel (DTCH).

The transitions between the states is controlled by a state machine of the RRC. When the UE is powered up, it is in a disconnected mode/idle mode. The UE may transit to RRC connected mode with an initial attach or with a connection establishment. If there is no activity from the UE for a short time, eNB/gNB may suspend its session by moving to RRC Inactive and can resume its session by moving to RRC connected mode. The UE can move to the RRC idle mode from the RRC connected mode or from the RRC inactive mode.

The actual user and control data from network to the UEs is transmitted via downlink physical channels, which in 5G include Physical downlink control channel (PDCCH) which carries the necessary downlink control information (DCI), Physical Downlink Shared Channel (PDSCH), which carries the user data and system information for user, and Physical broadcast channel (PBCH), which carries the necessary system information to enable a UE to access the 5G network.

The user and control data from UE to the network is transmitted via uplink physical channels, which in 5G include Physical Uplink Control Channel (PUCCH), which is used for uplink control information including HARQ (Hybrid Automatic Repeat reQuest) feedback acknowledgments, scheduling request, and downlink channel-state information for link adaptation, Physical Uplink Shared Channel (PUSCH), which is used for uplink data transmission, and Physical Random Access Channel (PRACH), which is used by the UE to request connection setup referred to as random access.

5G specifications provide an option to split the internal structure of a gNB into entities called CU (Central Unit) and one or more DUs (Distributed Unit), which are connected by a F1 interface, as specified in 3GPP 38.473. The split may provide traffic aggregation in terms of one gNB CU serving a plurality of gNB DUs operating as the actual node points for the air interface. The gNB-CU may be further split to CU-CP (Control Plane) and CU-UP (User Plane) and E1 interface has been introduced between them. Information of available resources and load must be shared across these network entities to implement various RRM (Radio Resource Management) functionalities.

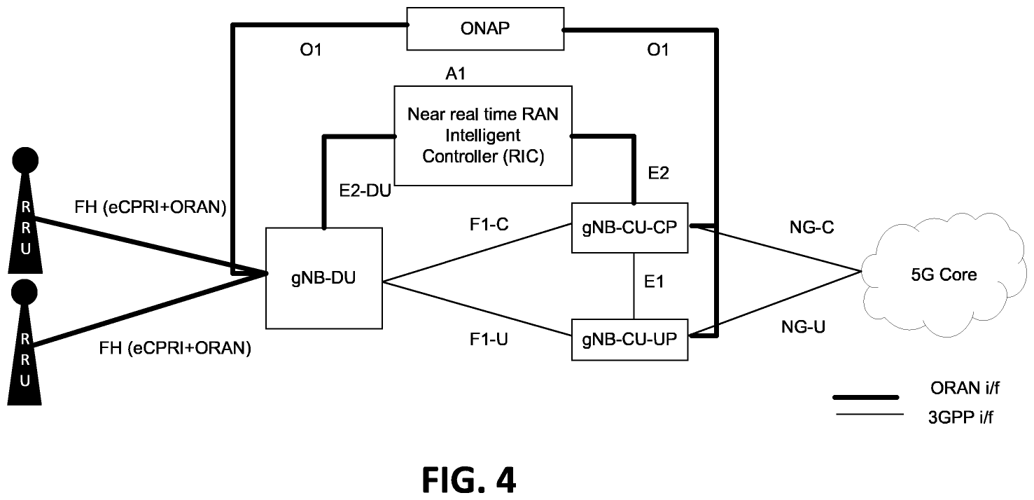

FIG. 4 provides a basic overview on the 5G deployment model for the split gNB. The gNB comprises a Centralized Unit (gNB-CU) and one or more Distributed Units (gNB-DUs) connected to the gNB-CU. gNB-CU is a logical node that includes the gNB functions like user data transfer, Mobility management, Radio access network sharing, Positioning, Session Management etc., except such functions, which are allocated exclusively to the gNB-DU. gNB-CU controls the operation of gNB-DUs over F1 interface. A RAN intelligent controller (RIC) is specified in ORAN (Open Radio Access Network) WG3 (Working Group 3). The RIC may be divided into functions of a non-real-time RIC and a near-real-time RIC. FIG. 4 shows a near-real-time RIC, where E2 interface is provided between the near-real-time RIC and E2 nodes (gNB-DU, gNB-CU-UP, gNB-CU-CP) as defined by ORAN WG3. The near-real-time RIC is a logical function that enables near-real-time control and optimization of RAN elements and resources via fine-grained (e.g. UE basis, Cell basis) data collection and actions over E2 interface. FIG. 4 also illustrates Open Networking Automation Platform (ONAP), which is an open source networking project intended to provide a further real-time platform for introducing and managing new services and resources in the entire network.

The DU's have a fixed computing resource/capacity used for establishing calls, handling U-plane data, scheduling etc. The DU's computing resources are further split among cells and the real time resources (such as FPGA (Field-Programmable Gate Array), ASIC (Application-Specific Integrated Circuit), hardware or CPU (Central Processing Unit) resources) within a cell are dedicated. The cells utilise their respective real time computing resources differently due to varying cell load and number of users. Baseband pooling leverages the advantage of pooling the computing resources between cells to ensure efficient utilization of DU resources based on cell loads.

Pooling of the real time baseband computing resources across cells accordingly enables the network operators to enhance their RANs with respect to better capacity. The bottleneck computing resources used for processing shared and dedicated physical layer channels in each cell may now be shared/pooled between the pooled set of cells taking advantage of the varying load and varying bearer requirements among cells. The inter cell resource allocator can judge which cells require extra capacity at any time and can assign the shared/pooled computing resources to said cell(s) during that time period. Thus, a specific cell can be run at full capacity at a specific time, but all cells in the resource pool cannot be run at full capacity at the same time. This helps operators to efficiently use baseband resources, support more cells per gNB-DU and provision baseband computing resources to average cell load rather than peak cell load.

Examples of bottleneck resources can be the baseband computing resources, for example used for PDCCH, PUCCH, SRS for beam management etc, whose average and peak dynamic capacity can be increased on cell level and TTI level with the pooling of the baseband computing resources across cells served by the baseband unit.

Current F1 interface (3GPP 38.473) and ORAN E2 interface have procedures defined for radio resource and hardware load reporting at cell level and network slice level. With baseband pooling, the computing resource load now depends also on other cells in the pool and hence requires load reporting at cell group or cell pool level. However, central control entities, like gNB-CU or near real time RIC functionality, have no means to know which baseband computing resources are shared/pooled e.g. by multiple cells, or which parameters are now dynamic per cell e.g. the maximum number of RRC connected UEs. Therefore, these central control components are not able to use this information to take decisions on RRM functionalities, such as admission control or load balancing. This lack of information can hinder efficient use of baseband resources when gNB-DU supports pooling functionality.

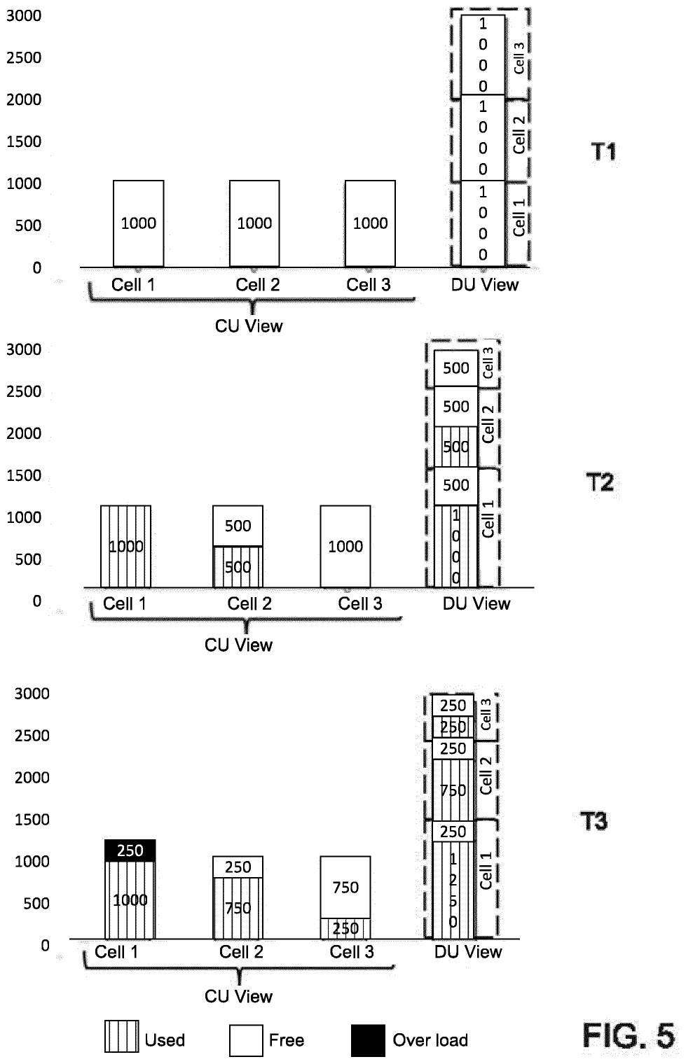

The above problem can be illustrated by an example of FIG. 5 showing how the available and maximum RRC capacity per cell (Cell1, Cell2, Cell3) varies dynamically with baseband pooling at three different time instants T1, T2 and T3. FIG. 5 also shows how the gNB-CU and the gNB-DU capacity views can be completely different if the pooling information is not shared.

At the first time instant T1, there is no activity in the cells of the pool and the gNB-CU and the gNB-DU capacity views are equal: The gNB-DU's baseband processing resource pool assumes 1000 units of available (and maximum) processing resources to each three cells Cell1, Cell2, Cell3, and both the gNB-CU and the gNB-DU are configured with this information of capacity view.

At the second time instant T2, the activity in Cell1 has increased such that it already consumes the whole 1000 units allocated previously by the baseband processing resource pool. Also in Cell2, half of the previously allocated processing resources are already in use. In Cell3, there is still no activity. Thus, the gNB-DU's baseband processing resource pool distributes 500 units of the available processing resources from Cell3 to Cell1, thereby alleviating the bottleneck in Cell1. However, since no cell pool level information is provided to the gNB-CU, the gNB-CU is not aware of the distribution of 500 units of the available processing resources from Cell3 to Cell 1.

At the third time instant T3, the activity in Cell1 has further increased such that it consumes the 1250 units of the 1500 units allocated previously by the baseband processing resource pool. However, the gNB-CU is only provided with cell level information about the used processing resources and the gNB-CU interprets the situation as Cell1 having an overload of 250 units over the assumed maximum of 1000 units.

Thus, gNB-CU's control decisions are not aligned to the actual capacity in the gNB-DU.

Therefore, it would be preferable to have a broader applicability of baseband resources for the gNB-DU pooling functionality.

In the following, an enhanced method for reporting baseband computing resources to a central unit will be described in more detail, in accordance with various embodiments.

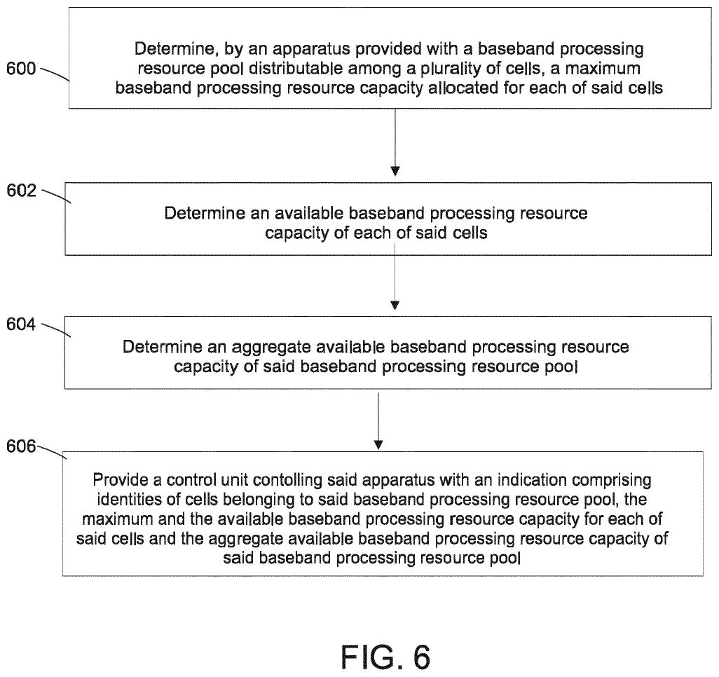

The method is disclosed in flow chart of FIG. 6 as reflecting the operation of an apparatus, such as a distributed unit of an access node, e.g. a gNB-DU, wherein the method comprises determining (600), by an apparatus provided with a baseband processing resource pool distributable among a plurality of cells, a maximum baseband processing resource capacity allocated for each of said cells; determining (602) an available baseband processing resource capacity of each of said cells; determining (604) an aggregate available baseband processing resource capacity of said baseband processing resource pool; and providing (606) a control unit controlling said apparatus with an indication comprising identities of cells belonging to said baseband processing resource pool, the maximum and the available baseband processing resource capacity for each of said cells and the aggregate available baseband processing resource capacity of said baseband processing resource pool.

Thus, the apparatus, which may be comprised in a distributed unit of an access node, e.g. a gNB-DU, has a pool of various baseband processing resources. The distributed unit may allocate the resources of the pool dynamically among a plurality of cells belonging to said pool. The distributed unit determines, at a given moment, the maximum baseband processing resource capacity allocated for each of said cells, as well as the available (non-used) baseband processing resource capacity of each of said cells. The distributed unit further determines the aggregate available baseband processing resource capacity of said baseband processing resource pool, for example by summing the available (non-used) baseband processing resource capacity of each of said cells.

The distributed unit then provides a control unit associated with said distributed unit with an indication, which comprises at least information about identities of cells belonging to said baseband processing resource pool, the maximum and the available baseband processing resource capacity for each of said cells and the aggregate available baseband processing resource capacity of said baseband processing resource pool. Such information enables the control unit to update the cell capacity view and align it to be the same in the distributed unit and in the control unit.

It is noted that providing the control unit with an indication may refer to sending the above information to the control unit in a single message. Alternatively, providing the control unit with an indication may refer to sending the above information to the control unit as distributed in a plurality of messages and/or a plurality of transmissions.

According to an embodiment, the distributed unit is a gNB-DU and the control unit is a gNB-CU, wherein said indication is provided over 3GPP F1 interface.

F1 Application Protocol has been specified in 3GPP as the interface between gNB-CU and gNB-DU. Current specification covers certain procedures, such as reset, setup, configuration, context setup, and resource reporting. However, the above information enables to address many limitations of the current specification, such as reporting/requesting cell pooling/grouping at DU between gNB-CU and gNB-DU, reporting/requesting resource and load information of cell pool/group between gNB-CU and gNB-DU, and admission control and other RRM functionalities based on cell pool/group information at gNB-CU.

The exchange of cell pooling information between gNB-DU and gNB-CU may comprise grouping the resource status reporting of all cells belonging to a pool into a single message without changing the F1 procedures. The resource status of different pools may be sent as different messages. This allows the gNB-CU to implicitly understand the cell-to-pool mapping.

According to an embodiment, the distributed unit is a gNB-DU and the control unit is a gNB-CU, wherein said indication is provided over 3GPP X2/Xn interface.

Dual Connectivity (DC) is a feature supported in LTE and in 5G NR enabling aggregation of two radio links at the PDCP (Packet Data Convergence Protocol) layer level. For resource aggregation, a UE in RRC_CONNECTED state is allocated two radio links from two different network nodes that may be connected via a non-ideal backhaul. The first node, Master Node (MN), serves as mobility and signaling anchor and the second node, Secondary Node (SN), provides additional local radio resources for UE. The two resource sets are called as Master Cell Group (MCG, associated with MN) and Secondary Cell Group (SCG, associated with SN). The MN can be either LTE eNB or NR gNB. The SN can be either LTE eNB or NR gNB. The MN and the SN can be the same node.

Dual Connectivity can improve user throughput and mobility robustness, since the users may be connected simultaneously to MCG and SCG, as well as improve load balancing between MCG and SCG resources.

The X2 interface used between eNBs in LTE is reused between RAN nodes in non-standalone operation between eNB and en-gNB and the Xn interface is newly specified between RAN nodes in standalone operation between ng-eNB/gNB and ng-eNB/gNB. When operating as the split gNB, the Xn interface provided between gNB-CUs. Herein, the indication may relate to the maximum and the available baseband processing resource capacity for each of said cells and the aggregate available baseband processing resource capacity of said baseband processing resource pool for load management application procedures over X2/Xn used by gNBs to inform resource status and overload status to each other.

According to an embodiment, the apparatus is comprised in a distributed unit of an access node and the control unit is comprised in a radio access network controller.

Thus, the distributed unit may be a gNB-DU and the control unit may be an RNC, for example.

According to an embodiment, the apparatus is comprised in a distributed unit of an access node and the control unit is comprised in a radio access network intelligent controller.

Thus, the distributed unit may be a gNB-DU and the control unit may be an RIC, for example. As mentioned above, the RIC may be divided into functionalities of a non-real-time RIC and a near-real-time (near RT) RIC. In the following, some embodiments are described using the near RT RIC as an illustrative example. It is, nevertheless, noted that the embodiments described in the context of near RT RIC are equally applicable in non-real-time RIC, unless specifically being limited to near RT RIC.

According to an embodiment, the distributed unit is a gNB-DU and the control unit is a near-real-time RIC, wherein said indication is provided over ORAN E2 interface.

E2 interface has been specified by ORAN as the interface between gNB and Near-Real-time Radio Intelligent Controller (RIC). Current specification covers procedures like setup, reset, subscription, control, update etc. E2 specification allows a gNB/eNB (E2 Node) to expose RAN functions towards near real time RIC. Near real time RIC use RIC subscription model to configure near real time RIC services like REPORT, INSERT, CONTROL and POLICY based on each occurrence of the event in the RAN functions exposed by E2 node.

However, the above information enables to address many limitations of the current specification, such as reporting/requesting cell pooling/grouping at DU between a near-real time RIC and gNB-DU, reporting/requesting resource and load information of cell pool/group between a near-real time RIC and gNB-DU, and runtime reconfiguration of participating cells in the cell pool/group in the gNB-DU by near-real-time RIC based on cell load information.

According to an embodiment, the baseband processing resources are shared among the cells belonging to the pool for RRC connections or bearers.

As an example, let us assume that the bottleneck resource in a gNB-DU is the real time computing resources for PUCCH per cell used for UCI (Uplink Control Information) and HARQ A/N (Hybrid Automatic Repeat reQuest Acknowledgement/Non-Acknowledgement), and the cell is a participant in any baseband pool in the gNB-DU. The DU's computing resources earlier reserved for PUCCH per cell is now pooled across all cells in the baseband pool, thus dynamically increasing the average and peak capability per cell to support additional
number of RRC connected UEs using PUCCH in a cell; and/or
number of UEs using PUCCH that can be scheduled per TTI in a cell.

The allocation of the additional PUCCH computing resources to a cell may be performed only if the other cells in the baseband pool have lesser number of RRC connected UEs requiring PUCCH resources at that time period. As a result, a decrease in the RRC admission capacity of the other cells in the baseband pool also take place during the time period, and the central entities outside the gNB-DU need to be informed about this.

According to an embodiment, the method comprises providing the control unit of said distributed unit with an indication comprising information about available processing power for the available baseband processing resource capacity. Thus, gNB-DU can also include information to indicate available hardware load for each of the pooled/shared baseband computing resources at cell and baseband pool level individually or as a composite value, for example, in the Resource status messages reported by the base station. The central intelligent components, such as the near real time RIC, may use the information to suggest runtime adaptive participation of cells to different baseband pools based on historic or real time dynamic load conditions.

The central control units, such as the gNB-CU and/or the near real time RIC can use the dynamic pooled/shared capacity information per cell and per pool to take better informed load aware control decisions. The decisions may include one or more of the following:
Load balancing and Admission control service for new RRC connected UEs or radio bearers;
Admission control for carrier aggregation and handover;
Runtime reconfiguration of participating cell IDs in each cell pool/group based on cell's historic and real time hardware and cell load data.

The interface application procedures may be enhanced to further indicate at least one of the following information:
Capability of the baseband to share/pool real time baseband computing resources across cells; and pooling boundaries (group of cells or entire baseband card) of the shared/pooled resources and the cells participating in pooling;
Shared/pooled computing resource capacity status; or composite available capacity group of the shared/pooled resources;
Shared/pooled resource overload indicator.

Embodiments relating to the above indications are described more in detail below.

### Procedures for Negotiating Resource Pooling Capabilities

According to an embodiment, the distributed unit is configured to inform its aggregate available baseband processing resource capacity of said baseband processing resource pool to be used for at least one participating cell of the baseband processing resource pool. The interface specification of the standard interfaces (F1, E2, Xn, etc.) can be enhanced to introduce application procedures for negotiating the computing resource pooling capabilities of the gNB-DU. The gNB-DU can advertise the different types of baseband computing resources it is capable to share/pool between the defined boundaries of cells or slices.

This negotiation procedure allows the gNB-DU to perform auto-negotiation of the shared/pooled resource capabilities with the central components like gNB-CU or near real time RIC, thus enabling the central components to communicate with a plurality of gNB-DU from multiple vendors with different resource pooling capabilities.

### Procedures for Informing Pooling Boundaries of the Shared/Pooled Resources

According to an embodiment, the distributed unit is configured to inform the control unit about changes in pooling boundaries of baseband processing resource pools supported by the distributed unit. The interface specification of the standard interfaces (F1, E2, Xn, etc.) can be enhanced to introduce application procedures for exchanging the pool IDs and cell-to-pool mapping for the different baseband shared/pooled resources in gNB-DU. The pooling boundary can be a group of cells or across the baseband unit itself and can vary based on the type of computing resource pooled and the use case for pooling.

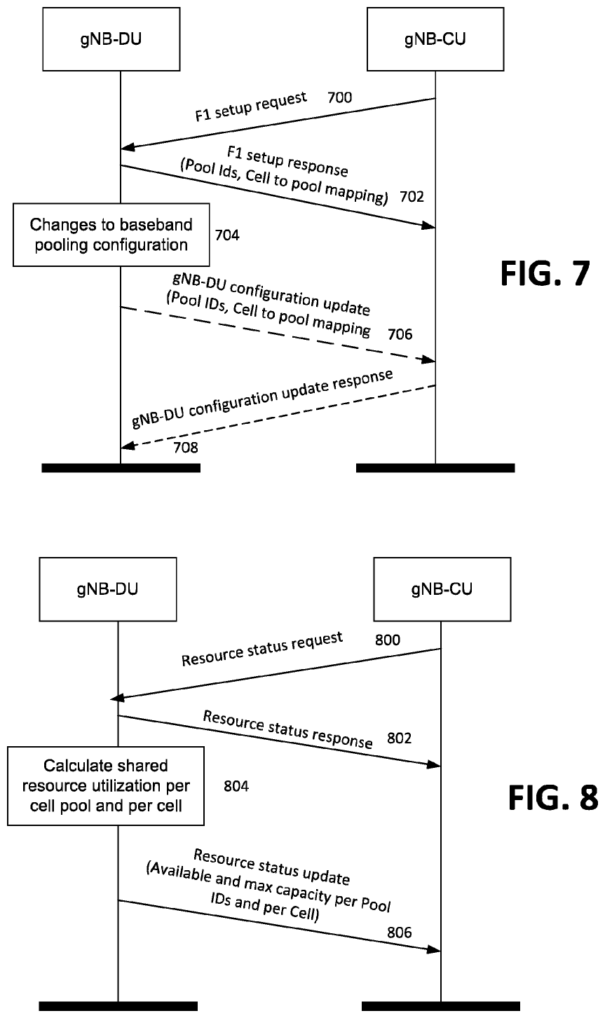

FIG. 7 shows an exemplified signalling chart for the exchange of cell pooling information over F1-AP. The gNB-CU initiates the operation by sending a F1 setup request (700) to the gNB-DU, and the gNB-DU acknowledges this by sending a F1 setup response (702), which comprises at least the pool IDs and cell-to-pool mapping for the different baseband shared/pooled resources currently configured in gNB-DU. Then a change takes place in the pooling boundaries of baseband processing resource pools in the gNB-DU (704); for example, a cell is included in or removed from a particular pool. The gNB-DU then initiates the update of the change by sending a gNB-DU configuration update (706), which may comprise e.g. the same information fields as the F1 setup response, but with updated parameter values. The gNB-CU then acknowledges this by sending a gNB-DU configuration update response (708) to the gNB-DU.

### Procedures for Reporting of Available and Maximum Capacity of Shared/Pooled Computing Resource at Cell Pool and Cell Level

According to an embodiment, the distributed unit is configured to inform its aggregate available and maximum baseband processing resource capacity of said baseband processing resource pool according to a configured reporting periodicity. Thus, the interface specification (F1, E2, Xn, etc.) can be enhanced to introduce new application procedures or reuse the existing resource status messages to include the available capacity at a cell pool level for the different shared/pooled baseband resources. The available capacity of the shared/pooled resources can be reported independently or as a composite available capacity group. The gNB-DU may be configured to report the capacity according to a value of a parameter, such as a ReportingPeriodicity parameter.

The shared/pooled resource available capacity information can be used by gNB-CU for control decisions, such as admission control of new RRC users or bearers in a cell, as well as deciding the carrier aggregation and handover capabilities.

The shared/pooled resource available capacity information can also be used by intelligent platforms like near real time RIC to predict or advice the gNB for future load balancing and admission control procedures or even propose adaptive pooling configurations.

FIG. 8 shows an exemplified signalling chart for reporting of available and maximum capacity at cell pool and cell level. The gNB-CU initiates the operation by sending a resource status request (800) to the gNB-DU, and the gNB-DU acknowledges this by sending a resource status response (802), which indicates that the requested measurement (804) is successfully initiated. The gNB-DU then reports the requested information about the utilisation of the baseband processing resources at cell level as well as at pool level by sending a resource status update (806) to the gNB-CU. This message may be reported by the gNB-DU according to the configured ReportingPeriodicity.

### Procedures for Threshold Triggered Resource Status Reporting

According to an embodiment, the distributed unit is configured to set at least one threshold value, received from a control unit, for a load in baseband processing resource allocation and send an update of its aggregate available and maximum baseband processing resource capacity of said baseband processing resource pool in response reaching said threshold value. For example, the reporting periodicity IE of the resource status message, which is used as a periodic reporting time interval, can be extended to configure the load threshold levels, as well. This information can be used by the reporting base station to automatically trigger the reporting of resource status updates, when the monitored resource levels cross the configured threshold value, or a plurality of threshold values, such as minimum and maximum threshold values.

Threshold triggered load reporting may provide advantages as the cardinality between the network entities are increasing, for example; CU-CP communicating with a plurality of CU-UP and gNB-DU entities.

Threshold triggered load reporting may provide advantages for base stations supporting resource pooling as the per cell capacity and resource usage is now dynamic across cell boundaries.

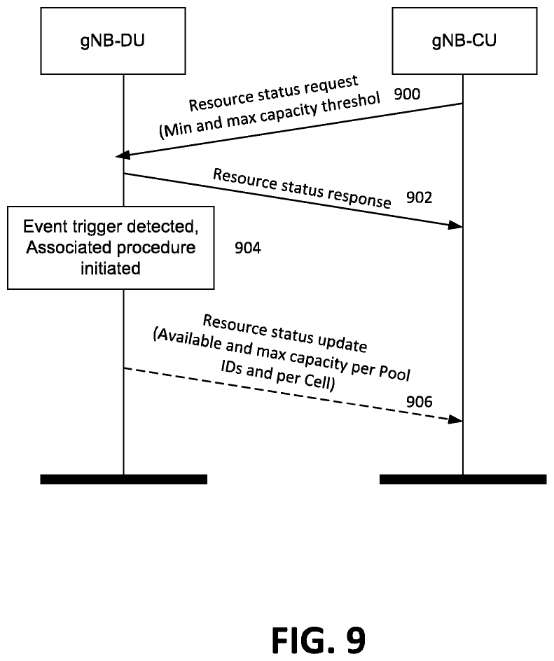

FIG. 9 shows an exemplified signalling chart for threshold triggered load reporting. The operation is otherwise similar to that of FIG. 8, with the exception that along with the resource status request (900) the gNB-CU also sends a minimum and a maximum threshold value for a load in baseband processing resource allocation to the gNB-DU. The gNB-DU sets the threshold values in its configuration and acknowledges the request by sending a resource status response (902) to the gNB-CU. Then an event triggering an action relating to the allocation of the baseband processing resources within a pool takes place in the gNB-DU (904), wherein the event may relate to the load in baseband processing resource allocation reaching the minimum or the maximum threshold value, whereupon a process of re-allocation of resources may be performed. The gNB-DU then autonomously initiates the update of the allocation change by sending a resource status update (906) to the gNB-CU.

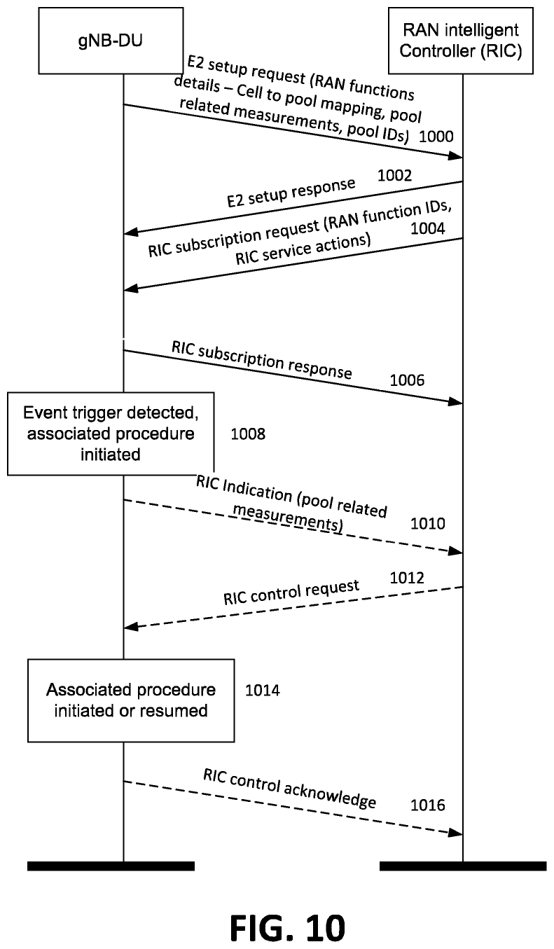

FIG. 10 shows a sequence diagram for messages exchanged on E2 interface to realise the above-described embodiments of information exchange between gNB-DU and gNB-CU to be implemented as information exchange between gNB and RIC, more specifically between gNB-DU and a near-real-time RIC (near-RT RIC).

During E2 setup request (1000), gNB-DU exposes the new RAN functions like shared/pooled baseband computing resource measurements (pool related measurements, pool IDs), pooling boundaries (cell to pool mapping) etc. New RAN functions need to be added to E2SM specification to exchange the information mentioned above. Near-RT RIC shall respond with RIC SETUP RESPONSE (1002), which comprises RAN Functions Accepted IE and the RAN Functions Rejected IE. The Near-RT RIC subscribes and configures RIC service actions for the exposed RAN functions mentioned above by initiating the procedure by sending the RIC SUBSCRIPTION REQUEST (1004) message to the E2 Node. The E2 Node acknowledges with RIC SUBSCRIPTION RESPONSE (1006) message back to the Near-RT RIC, which comprises accepted RIC service function IE and rejected RIC service function IE. The gNB-DU on detecting triggers for the subscribed RAN functions like shared/pooled baseband computing resource measurements, changes to pooling boundaries (cell to pool mapping) etc., and initiates the configured RIC service actions. Based on the configured RIC service action, the gNB-DU optionally reports the trigger event to Near-RT RIC via RIC indication (1010) message or/and apply the configured policy (1008) like admission control, changes to pooling boundaries etc. On reception of the RIC indication message, Near-RT RIC will update its database of baseband computing resource measurements, pooling boundaries etc. and can also optionally send RIC control request (1012) to gNB-DU to initiate actions for admission controls, changing pooling boundaries (1014) etc. The gNB-DU acknowledges this via RIC control acknowledge (1016) message to Near-RT RIC.

The above-described embodiments of information exchange procedures are applicable for the gNB-CU operating as an E2 node.

The method and the embodiments related thereto may also be implemented in an apparatus implementing an access point or a base station of a radio access network, such as an eNB or a gNB. An apparatus, such as a gNB, according to an aspect comprises means for determining, from a baseband processing resource pool distributable among a plurality of cells, a maximum baseband processing resource capacity allocated for each of said cells; means for determining an available baseband processing resource capacity of each of said cells; means for determining an aggregate available baseband processing resource capacity of said baseband processing resource pool; and means for providing a control unit controlling said apparatus with an indication comprising identities of cells belonging to said baseband processing resource pool, the maximum and the available baseband processing resource capacity for each of said cells and the aggregate available baseband processing resource capacity of said baseband processing resource pool.

According to an embodiment, the apparatus comprises means for sharing the baseband processing resources among the cells belonging to the pool for radio resource control (RRC) connections or bearers.

According to an embodiment, the apparatus comprises means for providing the control unit with an indication comprising information about available processing power for the available baseband processing resource capacity.

According to an embodiment, the apparatus comprises means for informing its aggregate available baseband processing resource capacity of said baseband processing resource pool to be used for at least one participating cell of the baseband processing resource pool.

According to an embodiment, the apparatus comprises means for informing the control unit about changes in pooling boundaries of baseband processing resource pools supported by the distributed unit.

According to an embodiment, the apparatus comprises means for informing its aggregate available and maximum baseband processing resource capacity of said baseband processing resource pool in response to a change in baseband processing resource allocation.

According to an embodiment, the apparatus comprises means for setting at least one threshold value, received from a control unit, for a load in baseband processing resource allocation; and means for sending an update of its aggregate available and maximum baseband processing resource capacity of said baseband processing resource pool in response reaching said threshold value.

According to an embodiment, the apparatus comprises means for receiving, from the control unit, runtime reconfiguration of participating cells in the cell pool/group defined based on cell load information.

An apparatus, such as an access point or a base station of a radio access network, e.g. an eNB or a gNB, according to a further aspect comprises at least one processor and at least one memory, said at least one memory stored with computer program code thereon, the at least one memory and the computer program code configured to, with the at least one processor, cause the apparatus at least to perform: determine, from a baseband processing resource pool distributable among a plurality of cells, a maximum baseband processing resource capacity allocated for each of said cells; determine an available baseband processing resource capacity of each of said cells; determine an aggregate available baseband processing resource capacity of said baseband processing resource pool; and provide a control unit controlling said apparatus with an indication comprising identities of cells belonging to said baseband processing resource pool, the maximum and the available baseband processing resource capacity for each of said cells and the aggregate available baseband processing resource capacity of said baseband processing resource pool.

Such apparatuses may comprise e.g. the functional units disclosed in any of the FIGS. 1-4 for implementing the embodiments.

A further aspect relates to a computer program product, stored on a non-transitory memory medium, comprising computer program code, which when executed by at least one processor, causes an apparatus at least to perform: determine, from a baseband processing resource pool distributable among a plurality of cells, a maximum baseband processing resource capacity allocated for each of said cells; determine an available baseband processing resource capacity of each of said cells; determine an aggregate available baseband processing resource capacity of said baseband processing resource pool; and provide a control unit controlling said apparatus with an indication comprising identities of cells belonging to said baseband processing resource pool, the maximum and the available baseband processing resource capacity for each of said cells and the aggregate available baseband processing resource capacity of said baseband processing resource pool.

In general, the various embodiments of the invention may be implemented in hardware or special purpose circuits or any combination thereof. While various aspects of the invention may be illustrated and described as block diagrams or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, California and Cadence Design, of San Jose, California automatically route conductors and locate components on a semiconductor chip using well established rules of design as well as libraries of pre stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended examples. However, all such and similar modifications of the teachings of this invention will still fall within the scope of this invention.

1. An apparatus comprising:
at least one processor; and
at least one memory including computer program code stored thereon, the at least one memory and the computer program code configured to, with the at least one processor, cause the apparatus at least to:
determine, from a baseband processing resource pool distributable among a plurality of cells, a maximum baseband processing resource capacity allocated for each of said cells;
determine an available baseband processing resource capacity of each of said cells;
determine an aggregate available baseband processing resource capacity of said baseband processing resource pool; and
provide a control unit controlling said apparatus with an indication comprising identities of cells belonging to said baseband processing resource pool, the maximum and the available baseband processing resource capacity for each of said cells and the aggregate available baseband processing resource capacity of said baseband processing resource pool.

2. The apparatus according to claim 1, wherein the apparatus is comprised in a distributed unit of an access node and the control unit is comprised in a central unit of said access node.

3. The apparatus according to claim 2, wherein said indication is provided over F1 interface or over X2/Xn interface.

4. The apparatus according to claim 1, wherein the apparatus is comprised in a distributed unit of an access node and the control unit is comprised in a radio access network controller.

5. The apparatus according to claim 1, wherein the apparatus is comprised in a distributed unit of an access node and the control unit is comprised in a radio access network intelligent controller, wherein said indication is provided over E2 interface.

6. The apparatus according to claim 5, wherein the control unit is comprised in a near-real-time radio access network intelligent controller.

7. The apparatus according to claim 1, wherein the at least one memory and computer program code are further configured, with the at least one processor, to cause the apparatus to:
share the baseband processing resources among the cells belonging to the pool for radio resource control connections or bearers.

8. The apparatus according to claim 1, wherein the at least one memory and computer program code are further configured, with the at least one processor, to cause the apparatus to:
provide the control unit with an indication comprising information about available processing power for the available baseband processing resource capacity.

9. The apparatus according to claim 1, wherein the at least one memory and computer program code are further configured, with the at least one processor, to cause the apparatus to:
inform its aggregate available baseband processing resource capacity of said baseband processing resource pool to be used for at least one participating cell of the baseband processing resource pool.

10. The apparatus according to claim 1, wherein the at least one memory and computer program code are further configured, with the at least one processor, to cause the apparatus to:
inform the control unit about changes in pooling boundaries of baseband processing resource pools supported by the distributed unit.

11. The apparatus according to claim 1, wherein the at least one memory and computer program code are further configured, with the at least one processor, to cause the apparatus at least to:
inform its aggregate available and maximum baseband processing resource capacity of said baseband processing resource pool in response to a change in baseband processing resource allocation.

12. The apparatus according to claim 1, wherein the at least one memory and computer program code are further configured, with the at least one processor, to cause the apparatus at least to:
set at least one threshold value, received from a control unit, for a load in baseband processing resource allocation; and
send an update of its aggregate available and maximum baseband processing resource capacity of said baseband processing resource pool in response reaching said threshold value.

13. The apparatus according to claim 1, wherein the at least one memory and computer program code are further configured, with the at least one processor, to cause the apparatus at least to:
receive, from the control unit, runtime reconfiguration of participating cells in the cell pool/group defined based on cell load information.

14. A method comprising:
determining, by an apparatus provided with a baseband processing resource pool distributable among a plurality of cells, a maximum baseband processing resource capacity allocated for each of said cells;
determining an available baseband processing resource capacity of each of said cells;
determining an aggregate available baseband processing resource capacity of said baseband processing resource pool; and
providing a control unit controlling said apparatus with an indication comprising identities of cells belonging to said baseband processing resource pool, the maximum and the available baseband processing resource capacity for each of said cells and the aggregate available baseband processing resource capacity of said baseband processing resource pool.

15. The method according to claim 14, wherein the apparatus is comprised in a distributed unit of an access node and the control unit is comprised in a central unit of said access node.

16. The method according to claim 15, comprising
providing said indication over F1 interface or over X2/Xn interface.

17. The method according to claim 14, wherein the apparatus is comprised in a distributed unit of an access node and the control unit is a radio access network intelligent controller, wherein said indication is provided over E2 interface.

18. The method according to claim 14, wherein the baseband processing resources are shared among the cells belonging to the pool for radio resource control connections or bearers.
